(19) United States
(12) Patent Application Publication
(10) Pub. No.: US 2003/0194117 A1
(43) Pub. Date: Oct. 16, 2003

(54) Medical image processing apparatus, medical image processing method, and program

(76) Inventor: Jiro Okuzawa, Tokyo (JP)

Correspondence Address: Squire, Sanders & Dempsey L.L.P., Suite 300, One Maritime Plaza, San Francisco, CA, 94111, US

(21) Appl. No.: 10/408,014

(22) Filed: Apr. 3, 2003

(30) Foreign Application Priority Data
Apr. 16, 2002 (JP) JP2002-113346

(51) Int. Cl. G06K 9/00

(52) U.S. Cl. 382/128

(57) ABSTRACT

There is described a medical image processing apparatus, which makes it easy to perform operations for setting image processing contents, so as to improve the operating efficiency of the apparatus. The apparatus includes an image data storage to store medical image data; a parameter storage to store contents of the image processing parameter; a processing-parameter selecting section to select a specific image-processing parameter out of image processing parameters stored in the parameter storage; an inputting section to input new contents of the specific image-processing parameter; a confirmation-image displaying section to display a confirmation image for confirming a result of changed contents of said specific image-processing parameter. The confirmation image is generated by applying an image processing to the medical image data retrieved from the image data storage, based on the new contents inputted by said inputting section.

### BACKGROUND OF THE INVENTION

The present invention relates to a medical image processing apparatus, a medical image processing method, and a program thereof.

In recent years, a medical image processing apparatus for performing various image processing for medical images inputted as digital images by input devices (for example, various medical image radiographic devices such as a CT (Computed Tomography) device using radiant rays and an MRI (Magnetic Resonance Imaging) device or various medical image readers such as a CR (Computed Radiography) device and a DR (Digital Radiography) device using an FPD (Flat Panel Detector)) and displaying them on a monitor such as a CRT or outputting them to a film output device has been developed. By observing images made visible by such a medical image processing apparatus, a doctor can make a precise diagnosis.

In a medical image processing apparatus, on the basis of image processing parameters (hereinafter, also referred to as processing parameters) corresponding to inputted photographing conditions such as a photographing portion, a photographing direction, etc., (hereinafter, also referred to as scanning conditions such as a scanning slice position, a scanning direction, etc.), an image process is performed for a medical image obtained from a medical image reader, thus a suitable image process according to the scanning conditions is performed. To one scanning condition, one processing parameter is made correspond. To one processing parameter, one or more scanning conditions are made correspond. Contents of a processing parameter are specified by default, though a user can reset the contents of the processing parameter according to his idea. When the contents of the processing parameter are changed, the image processing contents are also changed according to the changes.

FIG. 8 is a drawing showing an example of the conventional processing parameter setting screen 136. As shown in FIG. 8, on the left of the processing parameter setting screen 136, a list of processing parameters is indicated and when a processing parameter to be set is selected from the list, on the right of the screen, a list of the scanning conditions corresponding to the processing parameter is displayed. Between the list of processing parameters and the list of scanning conditions, the operation buttons corresponding to the selected processing parameter, for example, the buttons of name change, copy, deletion, insertion, and others are displayed. When the “Standard Setting” button of the operation buttons is pressed, the screen is moved to the standard setting screen 137 shown in FIG. 9 and the contents of the processing parameter can be changed.

FIG. 9 is a drawing showing an example of the standard setting screen 137 in conventional setting of processing parameters. As shown in FIG. 9, on the upper right of the standard setting screen 137, a selected processing parameter name is displayed as a processing name, and in the area thereunder, the contents which can be set are displayed, and when a numerical value is input or selected, a user can change the setting contents of the processing parameter.

However, in setting of contents of a processing parameter in a conventional medical image processing apparatus, the result of set contents cannot be immediately confirmed on an image. Therefore, to confirm whether the set contents are suitable or not, a medical image must be actually obtained from a medical image reader and an image process must be performed for the medical image obtained by the set processing parameter, thus adjustment of the contents of the processing parameter is complicated.

Further, the conventional setting of contents of a processing parameter is executed by selecting a processing parameter whose setting is to be changed and selecting or inputting a numerical value, so that for example, even when image processing under a scanning condition is not satisfactory and the image processing contents are to be changed, if a processing parameter corresponding to the scanning condition is not known, the image processing contents cannot be changed, and for a user having no knowledge on the processing parameter contents and image processing contents, adjustment for obtaining a desired image processing result is not easy.

### SUMMARY OF THE INVENTION

To overcome the abovementioned drawbacks in conventional medical image processing apparatus, it is an object of the present invention to provide a medical image processing apparatus, in which operations for setting image processing contents becomes easy to perform, so as to improve the operating efficiency of the apparatus.

Accordingly, to overcome the cited shortcomings, the abovementioned object of the present invention can be attained by medical image processing apparatus, methods and a computer program described as follow.

(1) An apparatus for processing medical image data, which represent a medical image captured by a photographing operation, based on an image processing parameter corresponding to a photographing condition for the photographing operation, the apparatus comprising: an image data storage to store the medical image data therein; a parameter storage to store contents of the image processing parameter therein; a processing-parameter selecting section to select a specific image-processing parameter, which is intended to be changed, out of image processing parameters stored in the parameter storage; an inputting section to input new contents to be changed for the specific image-processing parameter; a confirmation-image displaying section to display a confirmation image for confirming a result of changed contents of the specific image-processing parameter, the confirmation image being generated by applying an image processing to the medical image data retrieved from the image data storage, based on the new contents inputted by the inputting section; and a parameter rewriting section to rewrite the contents, currently stored in the parameter storage, with the new contents inputted by the inputting section.

(2) The apparatus of item 1, wherein the confirmation-image displaying section displays a plurality of confirmation images, which are different relative to each other, and each of which serves as the confirmation image, on the displaying screen.

(3) The apparatus of item 1, wherein the confirmation-image displaying section retrieves specific medical image data, which are processed by employing the specific image-processing parameter selected by the processing-parameter selecting section, from the image data storage, and applies an image-processing to the specific medical image data, based on the new contents inputted by the inputting section, so as to display the confirmation image on the displaying screen.

(4) The apparatus of item 1, wherein the confirmation-image displaying section simultaneously displays both the confirmation image and information including the photographing condition in respect to the confirmation image.

(5) The apparatus of item 2, further comprising: a confirmation-image switching section to switch the confirmation image, displayed on the displaying screen, to a specific confirmation image formed from specific medical image data, which are retrieved from the image data storage, and to which an image-processing based on the new contents, inputted by the inputting section, is applied.

(6) The apparatus of item 5, further comprising: a confirmation-image fixing section to fix a designated confirmation image, designated among the plurality of confirmation images, on the displaying screen by prohibiting a switching operation to be performed by the confirmation-image switching section.

(7) The apparatus of item 1, further comprising: a photographing-condition selecting section to select the photographing condition; and a parameter-determining section to determine the image processing parameter corresponding to the photographing condition selected by the photographing-condition selecting section; wherein the inputting section inputs the new contents to be changed for the image-processing parameter determined by the parameter-determining section.

(8) A method for processing medical image data, which represent a medical image captured by a photographing operation, based on an image processing parameter corresponding to a photographing condition for the photographing operation, the method comprising the steps of: storing the medical image data in an image data storage; storing contents of the image processing parameter in a parameter storage; selecting a specific image-processing parameter, which is intended to be changed, out of image processing parameters stored in the parameter storage; inputting new contents to be changed for the contents of the specific image-processing parameter; displaying a confirmation image for confirming a result of changed contents of the specific image-processing parameter on a displaying screen, the confirmation image being generated by applying an image processing to the medical image data retrieved from the image data storage, based on the new contents inputted in the inputting step; and rewriting the contents currently stored in the parameter storage with the new contents inputted in the inputting step.

(9) The method of item 8, wherein, in the displaying step, a plurality of confirmation images, which are different relative to each other, and each of which serves as the confirmation image, are displayed on the displaying screen.

(10) The method of item 8, wherein, in the displaying step, specific medical image data, processed by employing the specific image-processing parameter selected in the selecting step, are retrieved from the image data storage, and an image-processing based on the content, inputted in the inputting step, is applied to the specific medical image data, so as to display the confirmation image on the displaying screen.

(11) The method of item 8, wherein, in the displaying step, both the confirmation image and information including the photographing condition in respect to the confirmation image are simultaneously displayed.

(12) The method of item 9, further comprising the step of: switching the confirmation image, displayed on the displaying screen, to a specific confirmation image formed from specific medical image data, which are retrieved from the image data storage, and to which an image-processing based on the new contents, inputted in the inputting step, is applied.

(13) The method of item 12, further comprising the step of: fixing a designated confirmation image, designated among the plurality of confirmation images, on the displaying screen by prohibiting a switching operation to be performed in the switching step.

(14) The method of item 8, further comprising the steps of: selecting the photographing condition; and determining the image processing parameter corresponding to the photographing condition selected in the selecting-condition step; wherein a content to be changed for the image-processing parameter, determined in the determining step, is inputted in the inputting step.

(15) A computer program for processing medical image data, which represent a medical image captured by a photographing operation, based on an image processing parameter corresponding to a photographing condition for the photographing operation, the computer program comprising the executing steps of: storing the medical image data in an image data storage; storing a setting content of the image processing parameter in a parameter storage; selecting a specific image-processing parameter, whose setting content is intended to be changed, out of image processing parameters stored in the parameter storage; inputting a content to be changed for the contents of the specific image-processing parameter; displaying a confirmation image for confirming a result of changed contents of the specific image-processing parameter on a displaying screen, the confirmation image being generated by applying an image processing to the medical image data retrieved from the image data storage, based on the new contents inputted in the inputting step; and rewriting the setting content currently stored in the parameter storage with the new contents inputted in the inputting step.

Further, to overcome the abovementioned problems, other medical image processing apparatus, embodied in the present invention, will be described as follow:

(16) A medical image processing apparatus, characterized in that,

in the medical image processing apparatus, which obtains a photographed medical image (hereinafter, also referred to as a scanned medical image) and performs an image process on the basis of an image processing parameter corresponding to a photographing condition,

there are provided: a data base for storing a medical image; a storage means for storing setting contents of an image processing parameter; a processing parameter selection means for selecting an image processing parameter whose setting contents are to be changed among image processing parameters stored in the storage means; an input means for inputting the changing contents of the selected image processing parameter; a confirmation image display means for performing an image process for a medical image sampled from the data base on the basis of the input contents and displaying a confirmation image for confirming changed results of the image processing parameter contents on a display screen; and a rewriting means for rewriting the selected image processing parameter contents stored in the storage means with the input contents.

(17) A medical image processing method, characterized in that,

in the medical image processing method for obtaining a photographed medical image and performing an image process on the basis of an image processing parameter corresponding to a photographing condition,

there are included: a step of storing setting contents of an image processing parameter in a storage means; a step of selecting an image processing parameter whose setting contents are to be changed among image processing parameters stored in the storage means; a step of inputting the changing contents of the selected image processing parameter; a step of performing an image process for a medical image sampled from the data base storing medical images on the basis of the input contents and displaying a confirmation image for confirming changed results of the image processing parameter contents on a display screen; and a step of rewriting the selected image processing parameter contents stored in the storage means with the input contents.

(18) A program for computer for controlling a medical image processing apparatus for obtaining a photographed medical image and performing an image process on the basis of an image processing parameter corresponding to a photographing condition, realizing: a function of storing setting contents of an image processing parameter in a storage means; a function of selecting an image processing parameter whose setting contents are to be changed among image processing parameters stored in the storage means; a function of inputting the changing contents of the selected image processing parameter; a function of performing an image process for a medical image sampled from the data base storing medical images on the basis of the input contents and displaying a confirmation image for confirming changed results of the image processing parameter contents on a display screen; and a function of rewriting the selected image processing parameter contents stored in the storage means with the input contents.

According to the invention mentioned in the above, the medical image processing apparatus has a storage means for storing setting contents of an image processing parameter, selects an image processing parameter whose setting contents are to be changed, inputs the changing contents, thereby performs an image process for a medical image sampled from a data base on the basis of the input changed contents, displays a confirmation image for confirming the changed results of the image processing parameter contents on a display screen, and after confirmation, rewrites the setting contents stored in the storage means. Therefore, the changed results of the image processing parameter contents can be confirmed immediately, so that in order to confirm as conventional whether the set contents are suited or not, a complicated process of actually obtaining a medical image from a medical image reader and performing an image process for a medical image obtained on the basis of the set processing parameter is not required and the convenience is improved.

(19) The medical image processing apparatus recited in item 16, characterized in that, the confirmation image display means displays a plurality of confirmation images being different relative to each other.

According to the invention mentioned in the above, the medical image processing apparatus displays a plurality of different confirmation images for confirming changed results of image processing parameter contents. Therefore, what image processing results are obtained by changing image processing parameter contents depending on the photographing position and characteristics of an object can be compared with each other and the medical image processing apparatus can be adjusted so as to set an image processing parameter free of deviation due to the photographing slice position and characteristics of an object.

(20) The medical image processing apparatus recited in item 16 or item 19, characterized in that the confirmation image display means displays a confirmation image for sampling the medical image subjected to the image process by the selected image processing parameter from the data base, performing an image process for the sampled medical image on the basis of the input contents, and confirming the changed results of the image processing parameter contents on a display screen.

According to the invention mentioned in the above, the medical image processing apparatus displays a confirmation image for sampling the medical image subjected to the image process by the selected image processing parameter, performing an image process for the sampled medical image on the basis of the input changed contents, and confirming the changed results of the image processing parameter contents on a display screen. Therefore, the medical image under the photographing condition that the image process is performed by the selected image processing parameter is displayed as a confirmation image, so that the changed results of the image processing parameter can be confirmed more precisely.

(21) The medical image processing apparatus recited in anyone of items 16, 19 and 20, characterized in that the confirmation image display means displays information including the photographing condition of the confirmation image together with the confirmation image.

According to the invention mentioned in the above, the medical image processing apparatus displays information including the photographing condition of the displayed confirmation image together with the confirmation image. Therefore, information such the photographing condition of the displayed confirmation image can be easily known and the convenience is improved.

(22) The medical image processing apparatus recited in anyone of items 16 and 19-21, characterized in that the medical image processing apparatus further provided with a confirmation image switching means for sampling a medical image different from the confirmation image displayed on the display screen from the data base, performing an image process for the sampled medical image on the basis of the input contents, and switching and displaying the confirmation image for confirming the changed results of the image processing parameter contents.

According to the invention mentioned in the above, the medical image processing apparatus switches and displays the confirmation image for sampling a medical image different from the confirmation image displayed on the display screen from the data base, performing an image process for the sampled medical image on the basis of the input contents, and confirming the changed results of the image processing parameter contents. Therefore, what image processing results are obtained by changing image processing parameter contents depending on the photographing position and characteristics of an object can be compared with more images.

(23) The medical image processing apparatus recited in item 22, characterized in that the medical image processing apparatus further provided with a confirmation image fixing means for making invalid to fix displaying of a designated confirmation image among a plurality of different confirmation images displayed on the display screen and switch by the confirmation image switching means.

According to the invention mentioned in the above, the medical image processing apparatus makes invalid to fix displaying of a designated confirmation image among a plurality of different confirmation images displayed on the display screen and switch by the confirmation image switching means. Therefore, a confirmation image desired by a user can be kept displayed on the display screen, so that for example, confirmation images under the same photographing condition are fixed and displayed and image processing results of objects for each characteristic under the photographing condition can be compared, and confirmation images under different photographing conditions are displayed and image processing results for each photographing condition can be compared, thus the convenience is improved more.

(24) The medical image processing apparatus recited in anyone of items 16 and 19-23, characterized in that the medical image processing apparatus further provided with a photographing condition selection means for selecting a photographing condition and a processing parameter discrimination means for discriminating an image processing parameter corresponding to the selected photographing condition, and the input means inputs the changed contents of the discriminated image processing parameter.

According to the invention mentioned in the above, the medical image processing apparatus, when a photographing condition is selected, can discriminate an image processing parameter corresponding to the selected photographing condition. Therefore, when image processing under a photographing condition is not satisfactory and the image processing contents are to be changed, a photographing condition is directly designated, thus the contents of the corresponding image processing parameter can be changed, so that adjustment for obtaining desired image processing results can be made easily.

### BRIEF DESCRIPTION OF THE DRAWINGS

Other objects and advantages of the present invention will become apparent upon reading the following detailed description and upon reference to the drawings in which:

FIG. 1 is a drawing conceptually showing the whole constitution of the medical image reading system 100 relating to the present invention;

FIG. 2 is a block diagram showing the functional constitution of the controller 1 shown in FIG. 1;

FIG. 3 is a drawing showing the processing parameter list screen 131 displayed on the display unit 13 shown in FIG. 2;

FIG. 4 is a drawing showing the scanning condition list screen 132 displayed on the display unit 13 shown in FIG. 2;

FIG. 5 is a drawing showing the simple edit screen 133 displayed on the display unit 13 shown in FIG. 2;

FIG. 6 is a drawing showing the detail edit screen 134 displayed on the display unit 13 shown in FIG. 2;

FIG. 7 is a drawing showing the LUT setting screen 135 displayed on the display unit 13 shown in FIG. 2;

FIG. 8 is a drawing showing an example of the conventional processing parameter setting screen 136; and

FIG. 9 is a drawing showing an example of the standard setting screen 137 which is a conventional processing parameter contents setting (changing) screen.

### DETAILED DESCRIPTION OF THE PREFERRED EMBODIMENT

The embodiment of the present invention will be detailed in the following.

Further, in this embodiment, the controller 1 which will be described later has a function as the medical image processing apparatus stated in the claims of the present invention. Further, the control unit 11 which will be described later has functions as the confirmation image display means, rewriting means, confirmation image switching means, confirmation image fixing means, and processing parameter discrimination means stated in the claims of the present invention, and the user parameter table 172 of the storage unit 17 has a function as a storage means, and the image data base of the storage unit 17 has a function as a data base. Further, the input unit 12 has functions as a processing parameter selection means, an input means, and a scanning condition selection means.

Initially, the constitution of the embodiment will be detailed in the following.

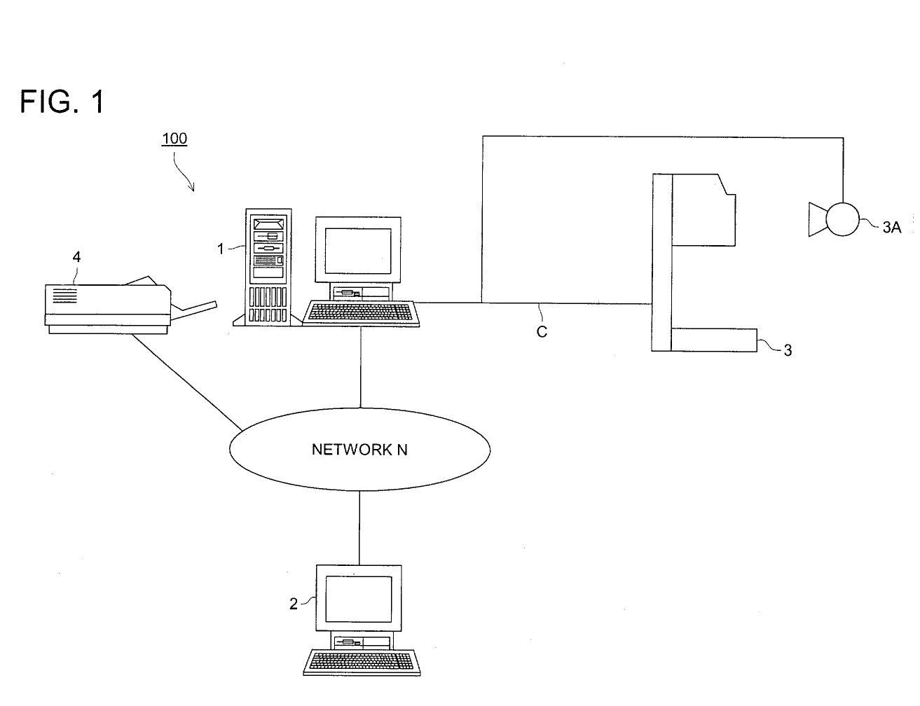

FIG. 1 is a drawing showing the whole constitution of the medical image reading system 100. As shown in FIG. 1, the medical image reading system 100 is composed of the controller 1, a reservation device 2, and a printer 4 which are connected so as to be able mutually to transmit and receive data via a network N and the controller 1 is connected to a reader 3 by a cable C. The medical image reading system 100 is constructed inside or outside a hospital and the controller 1 controls the operation of the reader 3. Further, FIG. 1 shows an example that the controller 1, the reservation device 2, the reader 3, and the printer 4 are connected one by one. However, the number of units thereof is not particularly restricted.

The controller 1 is connected to the reader 3 installed in a separate room via the cable C and connected to the reservation device 2 and the printer 4 via the network N. The controller receives reservation information from the reservation device 2, according to the reservation information and an input instruction by an operator such as a radiation engineer, controls the operation of the reader 3, executes radiography, thereby obtains medical image data, performs an image process for the obtained medical image data, and displays it on the display screen or outputs it to the printer 4.

The reservation device 2 is a terminal device for inputting reservation information concerning scanning of medical images and transmits the input reservation information to the controller 1 via the network N. Reservation information is information for reserving scanning of medical images by the medical image reading system 100 and for scanning of one medical image, inputting of one reservation information is necessary.

The reader 3 is a medical image reader having an X-ray radiation unit 3A (refer to FIG. 1) and when X rays are radiated from the X-ray radiation unit 3A by an instruction input from the controller 1 connected via the cable C, a laser beam is scanned on a sheet-like stimulant phosphor plate composed of laminated storage phosphors on the support which is stored once with radiation image information of an object such as a human body by X rays radiated from the X-ray radiation unit 3A, and the stored radiation image information is sequentially emitted stimulantly, and the stimulantly emitted light is photoelectrically read sequentially, and an image signal is obtained. The reader 3 transmits the image signal obtained in this way to the controller 1 as medical image data via the cable C. And, the reader 3, after reading the image signal, radiates erase light to the stimulant phosphor plate, discharges the radiation energy remaining in the plate, and sets up for the next scanning.

The printer 4 is an image forming device for printing image data, for example, on paper or a film, connected to the controller 1 via the network N, and upon receipt of medical image data from the controller 1, prints and outputs the received data.

The constitution of the controller 1 will be explained in detail hereunder by referring to the drawings.

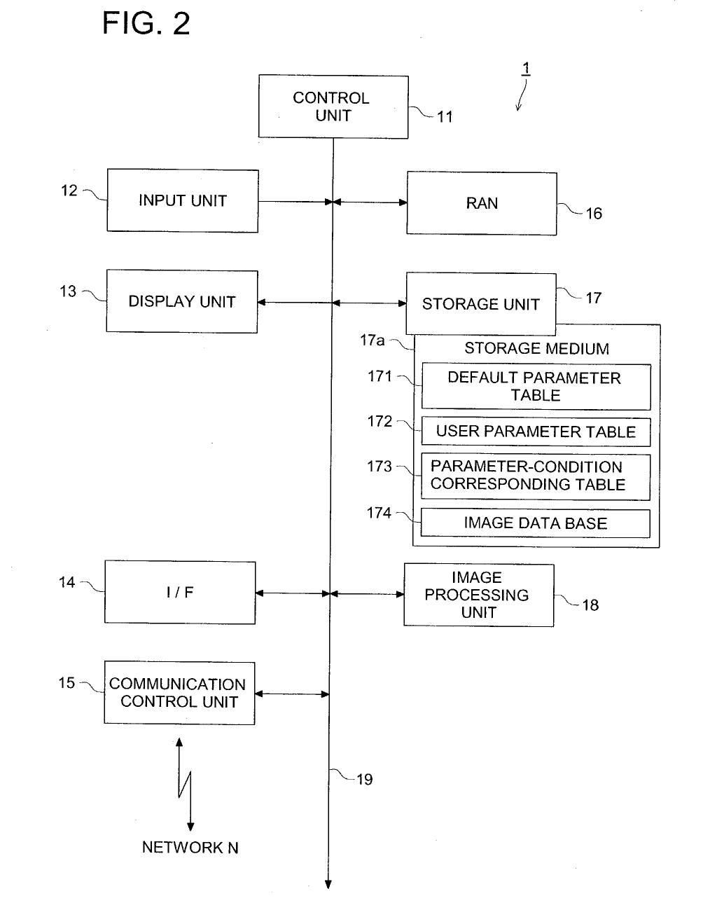

FIG. 2 is a block diagram showing the functional constitution of the controller 1. As shown in FIG. 2, the controller 1 is composed of the control unit 11, the input unit 12, the display unit 13, an interface 14, a communication control unit 15, an RAM 16, the storage unit 17, and an image processing unit 18 and the respective units are connected by a bus 19.

The control unit 11 is composed of a CPU (central processing unit), reads the system program and various control programs stored in the storage unit 17, stores them in the RAM 16, and intensively controls the operations of the units according to the stored programs. Further, the control unit 11, according to the programs stored in the RAM 16, executes various processes begging with the processing parameter contents changing process which will be described later, stores temporarily the processing results in the RAM 16, and simultaneously displays them on the display unit 13.

The input unit 12 is composed of a key board having cursor keys, numeric character input keys, and various function keys and outputs a signal corresponding to a pressed key of the key board to the control unit 11. Further, the input unit 12 may have a pointing device such as a mouse as required or other input devices. Or, the input unit 12 may be composed of a touch panel for outputting position information input by touching a transparent sheet panel covering the display screen of the display unit 13 by a finger or a dedicated stylus pen to the control unit 11 as input information.

The display unit 13 is composed of an LCD (liquid crystal display) or a CRT (cathode ray tube) and according to an instruction of a display signal input from the control unit 11, displays an input instruction or data from the input unit 12 on the display screen.

The interface 14 is an interface for connecting the controller 1 to the reader 3 via the cable C, obtains medical image data from the reader 3, and according to an instruction from the control unit 11, outputs the medical image data to the display unit 13 and the storage unit 17.

The communication control unit 15 is composed of a LAN adapter and a router or a TA (terminal adapter) and via a leased circuit or a communication circuit such as an ISDN circuit, controls communication with various devices connected to the network N. Upon receipt of medical image data via the network N, the communication control unit 15, according to an instruction from the control unit 11, outputs the medical image data to the storage unit 17 and the image processing unit 18. Further, the communication control unit 15 transmits processing data generated in the image processing unit 18 to the printer 4 via the network N.

The RAM (random access memory) 16, in various processes controlled by the control 11, forms a temporarily storage area for the system program, various processing programs, input or output data, and parameters which are read from the storage unit 17 and can be executed on the controller 1.

The storage unit 17 is composed of a nonvolatile semiconductor memory such as a HD (hard disk) and stores the system program corresponding to the controller 1, various processing programs corresponding to the system program, and processing results. Further, the storage unit 17 has a storage medium 17a storing programs and data beforehand. The recording medium 17a is a nonvolatile memory composed of a magnetic and optical recording medium or a semiconductor memory and mounted on the storage unit 17 in a fixed or removable state. The programs are stored in a form of readable program code and the control unit 11 successively executes operations according to the programs.

In this embodiment, the storage medium 17a is composed of a default parameter table 171, a user parameter table 172, a parameter-condition corresponding table 173, and an image data base 174. The default parameter table 171 stores default values of respective processing parameter contents. The user parameter table 172 is a table prepared by copying the default parameter table 171 and when contents of a processing parameter are changed by a user, rewrites and stores the contents to the changed contents. The parameter-condition corresponding table 173 stores a processing parameter and a scanning condition in a correspondence state. A one-to-N correspondence exists between a processing parameter and a scanning condition. The image data base 174 stores medical image data scanned in the past and information (patient name, scanning condition, scanning date, processing parameter, etc.) concerning the medical image data in a correspondence state.

The image processing unit 18, according to an instruction from the control unit 11, performs image processes, on the basis of a scanning condition and a processing parameter corresponding to the scanning condition, such as rotation processing, gradation processing, frequency processing, and equalization processing for medical image data input from the reader 3 or stored in the storage unit 17. Additionally, the image processing unit 18 performs a reduction process for medical image data, generates thumb-nail data displayed on the examination screen, and executes a compression process of compressing in a predetermined coded form and an expansion process of decoding and expanding compressed image data.

The network N is a communication network constructed using a leased line or an existing general public circuit and various circuit forms such as LAN (local area network) and WAN (wide area network) can be applied. In FIG. 1, an example that each device is wire-connected to the terminal is shown, though they may be wireless-connected to each other. However, from the viewpoint of reliability of information management, a network ensuring accessible security viewed from a specific user is desirable.

Next, the operation will be explained.

When a predetermined button of the input unit 12 is operated by a user and changing of contents of an image process is instructed, the control unit 11 starts the processing parameter content changing process. Firstly, the control unit 11 displays the selection screen for selecting whether changing of the image processing contents is to be performed from the processing parameter list screen or from the scanning condition list screen on the display unit 13.

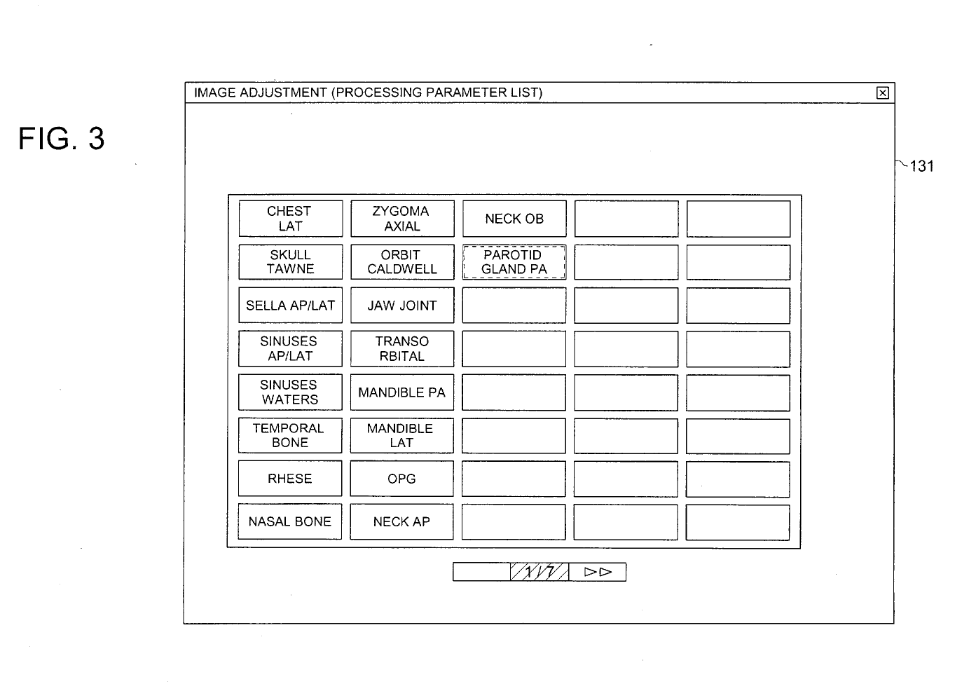

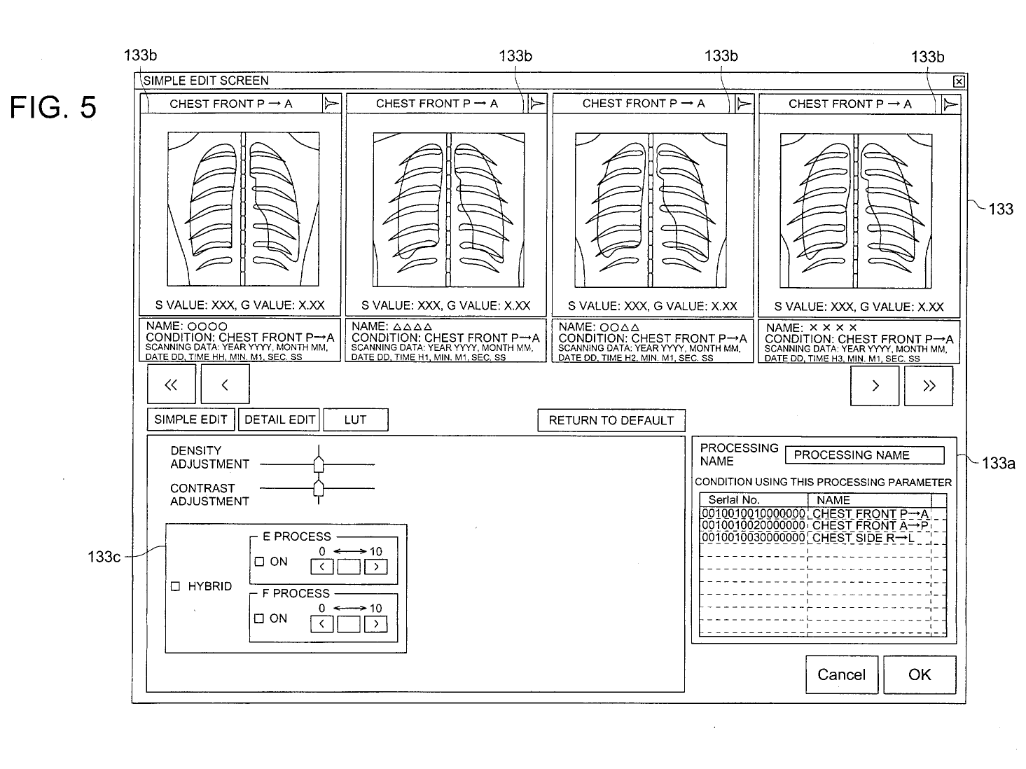

When the processing parameter list screen is selected from the selection screen, the control unit 11 displays the processing parameter list screen 131 on the display unit 13. As shown in FIG. 3, the processing parameter list screen 131 displays a list of the name buttons (for example, Chest LAT, Skull Tawne, Sella AP/LAT, - - - ) of the processing parameters in the center of the screen. On the lower part of the screen, a scroll button is displayed. When the arrow is pressed, the processing parameters to be displayed in a list can be switched to and displayed on another page. When a processing parameter whose contents are to be changed is selected by the user and the name button of the corresponding processing parameter is pressed, the control unit 11 sets the corresponding processing parameter as a processing parameter to be changed and displays, as shown in FIG. 5, the simple edit screen 133 for changing the processing parameter contents on the display unit 13.

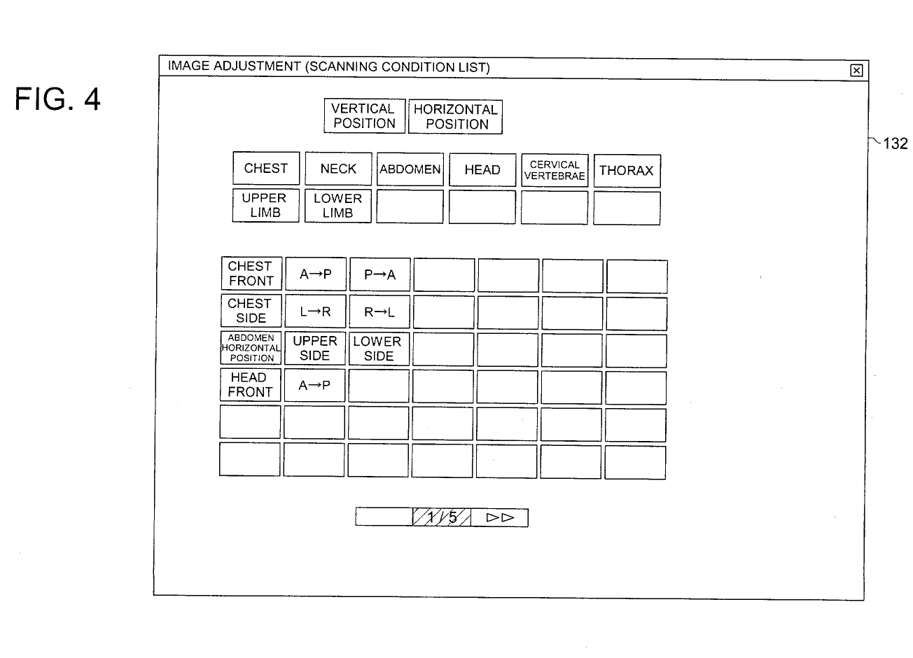

When the scanning condition list screen is selected from the selection screen, the control unit 11 displays the scanning condition list screen 132 on the display unit 13. As shown in FIG. 4, the scanning condition list screen 132 displays the posture selection buttons (“Vertical position” button, “Horizontal position” button) for selecting the posture among the scanning conditions on the upper part of the screen. Under them, the slice position selection buttons (“Chest” button, “Neck” button, “Abdomen” button, - - - ) for selecting the slice position are displayed. When a posture selection button and a slice position selection button are pressed, the control unit 11 displays the scanning condition choice buttons (“Chest front A→P”, “Chest front P→A”, - - - ) in the selected posture and slice position in the area under the slice position selection buttons. When one of the scanning condition choice buttons is pressed, the control unit 11 refers to the parameter-condition corresponding table 173, discriminates the processing parameter corresponding to the selected scanning condition, and as shown in FIG. 5, displays the simple edit screen 133 for changing the contents of the processing parameter corresponding to the selected scanning condition on the display unit 13.

FIG. 5 is a drawing showing an example of the simple edit screen 133. As shown in FIG. 5, an area 133a on the lower left of the screen of the simple edit screen 133 is a selection parameter display area for displaying information concerning a processing parameter selected as an object of content changing and when displaying the simple edit screen 133 on the display unit 13, the control unit 11 displays the processing parameter name which is an object of content changing as a processing name and under it, reads and displays all the scanning conditions corresponding to the concerned processing parameter from the parameter-condition corresponding table 173.

Four areas 133b on the upper part of the screen are sample image display areas and when displaying the simple edit screen 133 on the display unit 13, the control unit 11 reads an image for which the image process is performed by the processing parameter which is an object of content changing from the image data base 174 and displays four sample images (confirmation images). The sample images, for example, are displayed starting from the one of the newest scanning date among the medical image data scanned in the past. On the upper part of each of the sample image display areas 133b, the sample image scanning condition is displayed and on the lower part thereof, the data concerning the sample image such as name, scanning condition, and scanning date are displayed. Under the sample image areas 133b, the arrow buttons for switching and displaying the sample image are displayed and whenever one of the arrow buttons is pressed, the control unit 11 changes and displays the image to be displayed in the four sample image display areas 133b to another sample image. When the pin button displayed on the upper part of each of the sample image display areas 133b is pressed, the corresponding sample image is not switched to the next image even if the sample image switching operation is performed and the display is fixed. When the pin button is pressed again in a state that the sample image is fixed, the fixing is canceled. When the four sample images are displayed, what results are obtained by changing the contents of the processing parameter depending on the scanning slice position and characteristics of an object can be compared with each other and the medical image processing apparatus can be adjusted so as to set an image processing parameter free of deviation due to the scanning slice position and characteristics of an object.

An area 133c on the lower left of the screen is a setting area 133c and when a user operates this area, the contents of a processing parameter selected as an object according to the operation are changed and set. The density adjustment bar and contract adjustment bar displayed on the upper part of the setting area 133c are related to the G process (gradation process), and when the division of the density adjustment bar is operated by the mouse so as to move to the right, the control 11 performs the image process for the sample image whose displayed density is increased according to the movement distance and displays the processed image and when the division of the density adjustment bar is operated by the mouse so as to move to the left, the control 11 performs the image process for the sample image whose displayed density is decreased according to the movement distance and displays the processed image. When the division of the contrast adjustment bar is operated by the mouse so as to move to the right, the control unit 11 performs the image process for the sample image whose displayed contrast is increased according to the movement distance and displays the processed image and when the division of the contrast adjustment bar is operated by the mouse so as to move to the left, the control unit 11 performs the image process for the sample image whose displayed contrast is decreased according to the movement distance and displays the processed image.

In the lower part of the setting area 133c, the set contents concerning the hybrid process, E process (equalization process), and F process (frequency process) can be changed. When the display of hybrid is pointed by the mouse and checked, the control unit 11 performs the hybrid process (process of decomposing an image into a plurality of frequency bands, emphasizing so as to put the band components into an optimal balance ratio, and reconstructing them) for the sample image and displays the processed image.

When ON of the E process is pointed by the mouse and checked, the control unit 11 returns the numerical value setting field concerning the E process which is displayed in gray to the normal display, thus the contents of the processing parameter concerning the E process can be changed from the screen. When a numerical value is input into the numerical value setting field of the E process or the numerical value is changed by operating one of the arrow keys, the control unit 11 performs the E process for the sample image on the basis of the changed numerical value and displays the processed image. When ON of the F process is pointed by the mouse and checked, the control unit 11 returns the numerical value setting field concerning the F process which is displayed in gray to the normal display, thus the contents of the processing parameter concerning the F process can be changed from the screen. When a numerical value is input into the numerical value setting field of the F process or the numerical value is changed by operating one of the arrow keys, the control unit 11 performs the F process for the sample image on the basis of the changed numerical value and displays the processed image.

When during setting of a processing parameter in the setting area 133c, the contents are to be returned to the default, if the “Return to Default” button displayed in the center of the screen is pressed, the control unit 11 returns the set contents to the default from the pressed signal. When the “Detail Edit” button displayed on the central left of the screen is pressed, the control unit 11 displays the detail edit screen 134 capable of setting more detailed contents. When the “LUT” button is pressed, the control unit 11 displays the LUT setting screen 135 capable of changing the LUT table corresponding to the concerned processing parameter.

When the changing contents of the processing parameter are decided by the operation in the setting area 133c and the “OK” button displayed on the lower right of the screen is pressed, the control unit 11 rewrites and stores the contents of the processing parameter to be processed which are stored in the user parameter table 172 to the contents set by the simple edit screen 133. When the “Cancel” button is pressed, the control unit 11 finishes the concerned processing parameter content changing process without rewriting the contents of the processing parameter to be processed to the contents set by the simple edit screen 133.

As mentioned above, according to the simple edit screen 133, the contents of the processing parameter can be changed easily by the adjustment bars and the changed results can be confirmed immediately by comparing with a plurality of images displayed in the sample image display areas 133b, so that even a user having not so much knowledge on concrete contents of the processing parameter and image processing contents can adjust the processing parameter so as to easily perform an image process of a consistent idea.

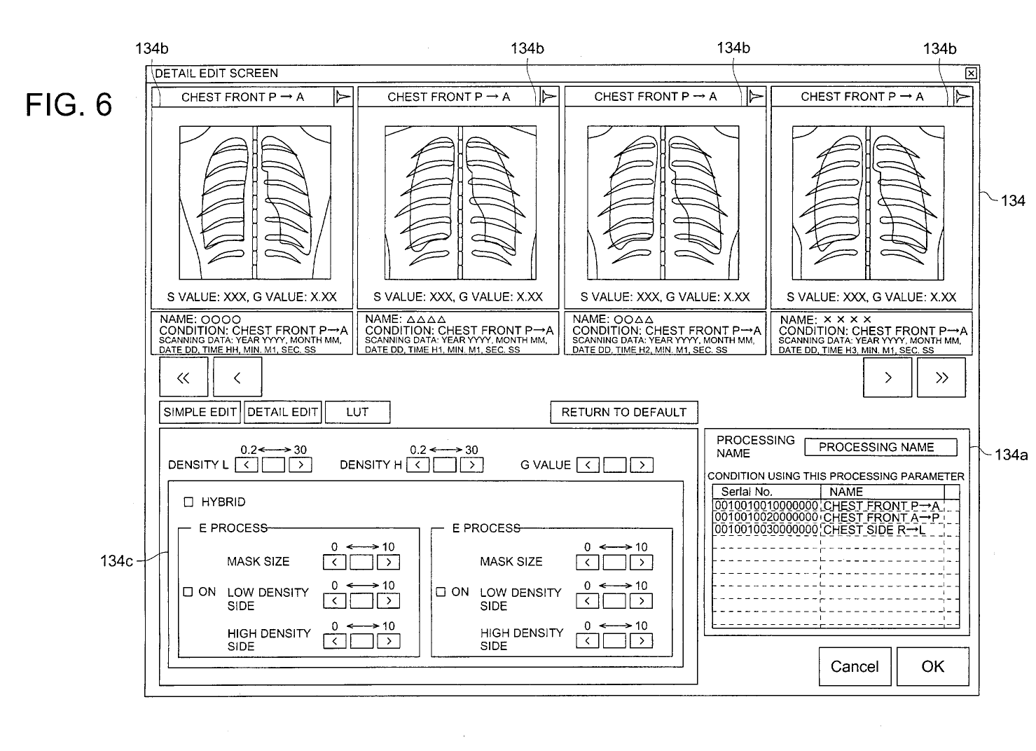

Next, the detail edit screen 134 displayed on the display unit 13 by pressing the “Detail Edit” button will be explained by referring to FIG. 6.

As shown in FIG. 6, the detail edit screen 134 is composed of a selection parameter display area 134a, sample image display areas 134b, a setting area 134c, and various function buttons (“Cancel”, “OK”, “LUT”, etc.), and the selection parameter display area 134a has the same constitution and function as those of the selection parameter display area 133a described above, and the sample image display area 134b has the same constitution and function as those of the sample image display area 133b, and various function buttons have the same constitutions and functions as those of the simple edit screen 133, so that the explanation will be omitted and the setting area 134c will be explained.

The setting area 134c, when a user operates the area, changes and sets the contents of the processing parameter to be processed according to the operation. Density L, Density H, and G value displayed on the upper part of the setting area 134c are fields for setting contents concerning the G process and when one of the arrow buttons is pressed in each of the setting fields and a numerical value is adjusted or a numerical value is directly input, the control unit 11 performs the image process for the sample image on the basis of the set numerical value and displays the processed image.

In the lower part of the setting area 134c, the set contents concerning the hybrid process, E process, and F process can be changed. When the display of hybrid on the lower part of the setting area 134c is pointed by the mouse and checked, the control unit 11 performs the hybrid process for the sample image and displays the processed image.

When ON of the E process is pointed by the mouse and checked, the control unit 11 returns the numerical value setting field concerning the E process which is displayed in gray to the normal display, thus the contents concerning the E process can be changed from the screen. When a numerical value is input into the numerical value setting field of the E process or the numerical values of Mask size, Low density side, and High density side are changed by operating one of the arrow keys, the control unit 11 performs the E process for the sample image on the basis of the changed numerical values and displays the processed image. When ON of the F process is pointed by the mouse and checked, the control unit 11 returns the numerical value setting field concerning the F process which is displayed in gray to the normal display, thus the contents concerning the F process can be changed from the screen. When a numerical value is input into the numerical value setting field of the F process or the numerical values of Mask size, Low density side, and High density side are changed by operating one of the arrow keys, the control unit 11 performs the F process for the sample image on the basis of the changed numerical values and displays the processed image.

When the changing contents of the processing parameter are decided by the operation in the setting area 134c and the “OK” button displayed on the lower right of the screen is pressed, the control unit 11 rewrites and stores the contents of the processing parameter to be processed which are stored in the user parameter table 172 to the contents set by the detail edit screen 134. When the “Cancel” button is pressed, the control unit 11 finishes the concerned processing parameter content changing process without rewriting the contents of the processing parameter to be processed to the contents set by the simple edit screen 134.

As described above, in the detail edit screen 134, compared with the simple edit screen 133, detailed setting concerning the G process, E process, and F process is possible and a user having a detailed knowledge of the processing parameters and image processing contents can execute thorough image process setting.

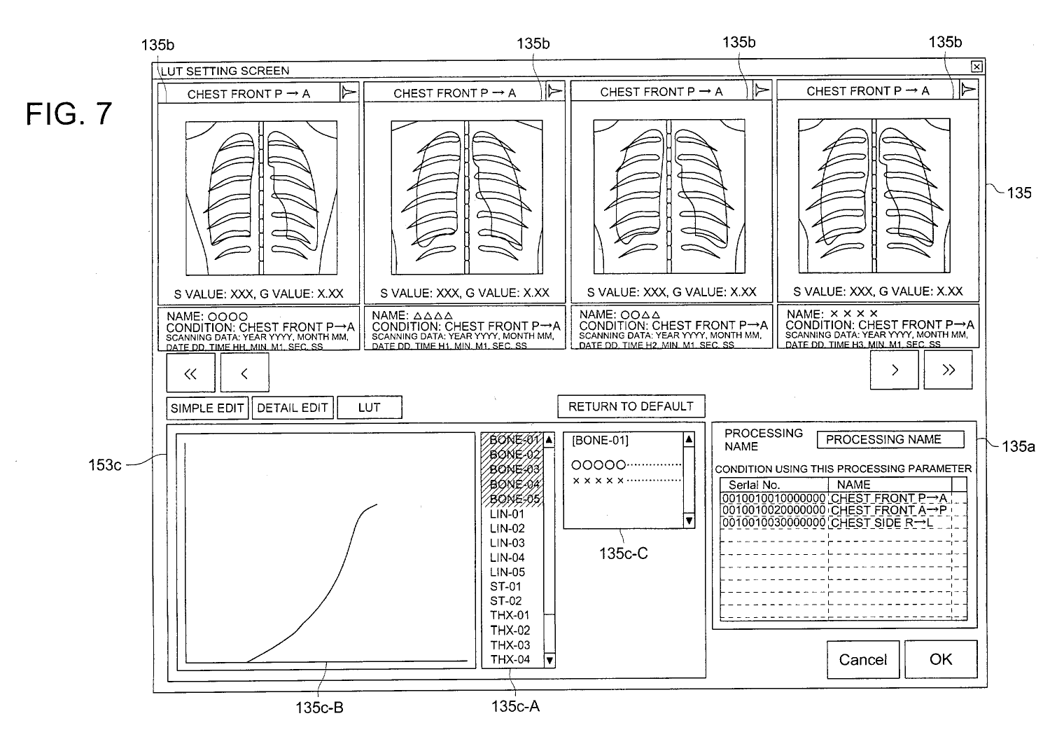

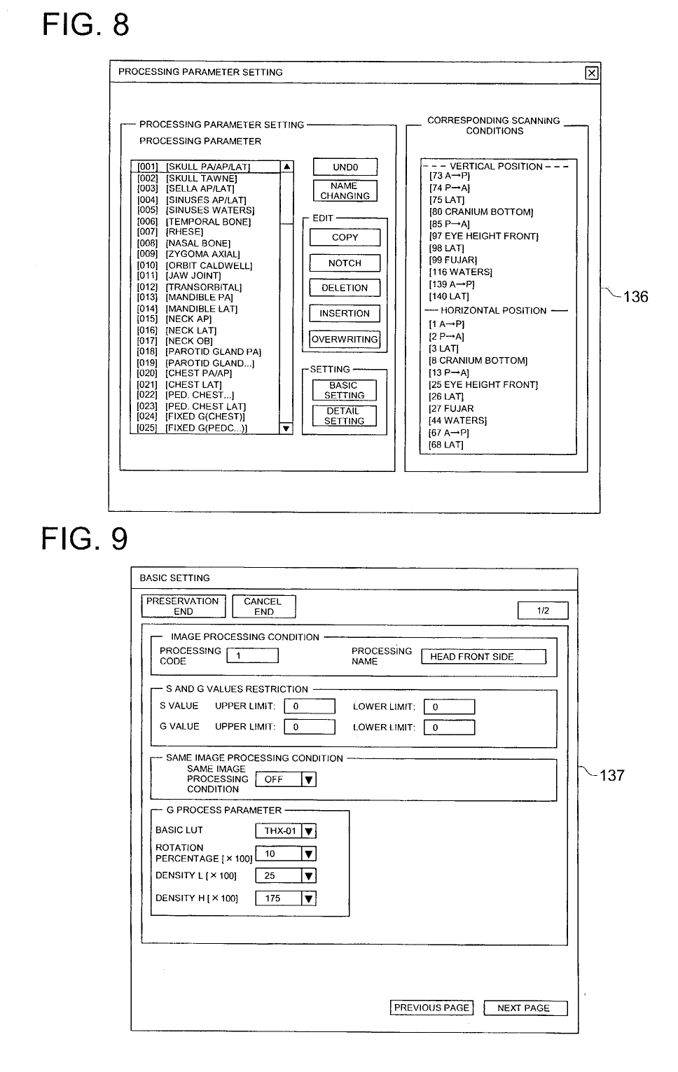

Next, the LUT setting screen 135 which is displayed on the display unit 13 when the “LUT” button is pressed on the simple edit screen 133 or the detail edit screen 134 will be explained by referring to FIG. 7.

As shown in FIG. 7, the LUT setting screen 135 is composed of a selection parameter display area 135a, sample image display areas 135b, a setting area 135c, and various function buttons (“Cancel”, “OK”, “LUT”, etc.), and the selection parameter display area 135a has the same constitution and function as those of the selection parameter display area 133a described above, and the sample image display area 135b has the same constitution and function as those of the sample image display area 133b, and various function buttons have the same constitutions and functions as those of the simple edit screen 133, so that the explanation will be omitted and the setting area 135c will be explained.

The setting area 135c, when a user operates the area, changes and sets the LUT (look-up table) corresponding to the processing parameter to be processed according to the operation. In a setting area 135c-A, a list of LUTs is displayed and when a desired LUT is selected from the LUT list, the control unit 11 displays a graph of the selected LUT in an area 135c-B and displays the explanation of the LUT in an area 135c-C. Further, the control unit 11 performs the image process for the sample image on the basis of the selected LUT and displays the processed image.

When the changing contents of the LUT corresponding to the processing parameter are decided by the operation in the setting area 135c and the “OK” button displayed on the lower right of the screen is pressed, the control unit 11 rewrites and stores the contents of the processing parameter to be processed which are stored in the user parameter table 172 to the contents set by the LUT setting screen 135. When the “Cancel” button is pressed, the control unit 11 finishes the concerned processing parameter content changing process without rewriting the contents of the processing parameter to be processed to the contents set by the LUT setting screen 135.

Further, even when any of the simple edit screen 133, the detail edit screen 134, and the LUT setting screen 135 is displayed, a user can freely move to another screen by pressing a predetermined button and perform a processing parameter setting operation.

As described above, according to the controller 1, when a user operates a predetermined button of the input unit 12 and instructs changing of the contents of the image process, the control unit 11 displays the selection screen for selecting whether changing of the image processing contents is to be performed from the processing parameter list screen or from the scanning condition list screen on the display unit 13. When the processing parameter list screen is selected, the control unit 11 displays the processing parameter list screen 131 and selects the processing parameter which is an object of content changing. When the scanning condition list screen is selected, the control unit 11 displays the scanning condition list screen 132, selects the scanning condition, discriminates the processing parameter corresponding to the selected scanning condition, and sets the processing parameter corresponding to the scanning condition as a processing parameter which is an object of content changing.

When the processing parameter which is an object of content changing is selected, the control unit 11, on the basis of an input instruction from the user, displays the simple edit screen 133 capable of easily changing the main contents of the processing parameter, or the detail edit screen 134 for changing the contents of the processing parameter more in detail, or the LUT setting screen 135 for changing the LUT corresponding to the processing parameter, reads, from the image data base 174, the image for which the image process is performed by the concerned processing parameter, and displays it in the sample image display area. When the changed contents are input by the operation of the adjustment bars from each screen or the input operation of a numerical value, the control unit 11 performs the image process for the sample image displayed on the basis of the changed processing parameter and displays the processed image. And, when the OK button is pressed, the control unit 11 rewrites and stores the contents of the user parameter table 172 on the basis of the changed contents.

Therefore, for example, when image processing under a scanning condition is not satisfactory and the image processing contents are to be changed, the scanning condition is directly designated, thus the contents of the corresponding processing parameter can be changed, so that adjustment for obtaining desired image processing results is made easy. Further, a user can change the contents of the processing parameter from a screen corresponding to his knowledge concerning the processing parameter and image processing contents and the operability of processing parameter setting is improved. Furthermore, before registering the changed contents, the changed results can be immediately confirmed by comparing a plurality of different images displayed in the sample image display areas, so that in order to confirm as conventional whether the set contents are suited or not, a complicated process of actually obtaining a medical image from a medical image reader and performing the image process for a medical image obtained by the set processing parameter is not required and the convenience is improved.

Further, the description contents of the aforementioned embodiment are a suitable example of the medical image processing apparatus relating to the present invention and not limited to it.

For example, the controller 1 is used as an example in description of this embodiment. However, the medical image processing apparatus of the present invention is not limited to it and any system having the medical image processing function is acceptable. For example, a server is connected to a medical image reader, thus the reader can be used as a medical image processing apparatus.

Further, this embodiment is structured so as to install the X-ray radiation unit 3A in the reader 3, control the reader 3 by the controller 1, and perform radiography. However, the present invention is not limited to it. For example, the reader 3 may be structured so as to mount a cassette storing a stimulant phosphor sheet composed of a sheet-like support and a stimulant phosphor used for radiography by the X-ray radiation unit not connected to the reader 3 in a removable state, take out the stimulant phosphor sheet stored in the mounted cassette, thereby scan it by excitation light under control by the control 1, stimulantly emit sequentially the stored and preserved radiation image information, sequentially read photoelectrically the stimulantly emitted light, thereby obtain an image signal, and transmit the scanned medical image data to the controller 1.

Further, in the aforementioned embodiment, four sample images can be displayed so as to confirm the changed results of processing parameter contents. However, the present invention is not limited to it.

Furthermore, the user parameter table 172 is prepared by copying the default parameter table 171 and when the processing parameter contents are changed, on the basis of the changed contents, the corresponding part of the user parameter table 172 is rewritten. However, only the changed contents may be stored in the user parameter table 172 and the image process may be performed by basically referring to the default parameter 171 and referring to the user parameter table 172 as for the contents stored in the user parameter table 172.

Furthermore, the medical image reading system 100 and detailed constitutions and detailed operations of the devices constituting the system can be properly changed within a range which is not deviated from the object of the present invention.

According to the present invention as described in the foregoing, the following effects can be attained.

(1) The medical image processing apparatus has a storage means for storing setting contents of an image processing parameter, selects an image processing parameter whose setting contents are to be changed, inputs the changing contents, thereby performs an image process for a medical image sampled from a data base on the basis of the input changed contents, displays a confirmation image for confirming the changed results of the image processing parameter contents on a display screen, and after confirmation, rewrites the setting contents stored in the storage means. Therefore, the changed results of the image processing parameter contents can be confirmed immediately, so that in order to confirm as conventional whether the set contents are suited or not, a complicated process of actually obtaining a medical image from a medical image reader and performing an image process for a medical image obtained on the basis of the set processing parameter is not required and the convenience is improved.

(2) The medical image processing apparatus displays a plurality of different confirmation images for confirming changed results of image processing parameter contents. Therefore, what image processing results are obtained by changing image processing parameter contents depending on the scanning position and characteristics of an object can be compared with each other and the medical image processing apparatus can be adjusted so as to set an image processing parameter free of deviation due to the scanning slice position and characteristics of an object.

(3) According to the aforementioned invention, the medical image processing apparatus displays a confirmation image for sampling the medical image subjected to the image process by the selected image processing parameter, performing an image process for the sampled medical image on the basis of the input changed contents, and confirming the changed results of the image processing parameter contents on a display screen. Therefore, the medical image under the scanning condition that the image process is performed by the selected image processing parameter is displayed as a confirmation image, so that the changed results of the image processing parameter can be confirmed more precisely.

(4) The medical image processing apparatus displays information including the scanning condition of the displayed confirmation image together with the confirmation image. Therefore, information such the scanning condition of the displayed confirmation image can be easily known and the convenience is improved.

(5) The medical image processing apparatus switches and displays the confirmation image for sampling a medical image different from the confirmation image displayed on the display screen from the data base, performing an image process for the sampled medical image on the basis of the input contents, and confirming the changed results of the image processing parameter contents. Therefore, what image processing results are obtained by changing image processing parameter contents depending on the scanning position and characteristics of an object can be compared with more images.

(6) The medical image processing apparatus makes invalid to fix displaying of a designated confirmation image among a plurality of different confirmation images displayed on the display screen and switch by the confirmation image switching means. Therefore, a confirmation image desired by a user can be kept displayed on the display screen, so that for example, confirmation images under the same scanning condition are fixed and displayed and image processing results of objects for each characteristic under the scanning condition can be compared, and confirmation images under different scanning conditions are displayed and image processing results for each scanning condition can be compared, thus the convenience is improved more.

(7) The medical image processing apparatus, when a scanning condition is selected, can discriminate an image processing parameter corresponding to the selected scanning condition. Therefore, when image processing under a scanning condition is not satisfactory and the image processing contents are to be changed, a scanning condition is directly designated, thus the contents of the corresponding image processing parameter can be changed, so that adjustment for obtaining desired image processing results can be made easily.

Disclosed embodiment can be varied by a skilled person without departing from the spirit and scope of the invention.

What is claimed is:

1. An apparatus for processing medical image data, which represent a medical image captured by a photographing operation, based on an image processing parameter corresponding to a photographing condition for said photographing operation, said apparatus comprising:
an image data storage to store said medical image data therein;
a parameter storage to store contents of said image processing parameter therein;
a processing-parameter selecting section to select a specific image-processing parameter, which is intended to be changed, out of image processing parameters stored in said parameter storage;
an inputting section to input new contents to be changed for said specific image-processing parameter;
a confirmation-image displaying section to display a confirmation image for confirming a result of changed contents of said specific image-processing parameter, said confirmation image being generated by applying an image processing to said medical image data retrieved from said image data storage, based on said new contents inputted by said inputting section; and
a parameter rewriting section to rewrite said contents, currently stored in said parameter storage, with said new contents inputted by said inputting section.

2. The apparatus of claim 1,
wherein said confirmation-image displaying section displays a plurality of confirmation images, which are different relative to each other, and each of which serves as said confirmation image, on said displaying screen.

3. The apparatus of claim 1,
wherein said confirmation-image displaying section retrieves specific medical image data, which are processed by employing said specific image-processing parameter selected by said processing-parameter selecting section, from said image data storage, and applies an image-processing to said specific medical image data, based on said new contents inputted by said inputting section, so as to display said confirmation image on said displaying screen.

4. The apparatus of claim 1,
wherein said confirmation-image displaying section simultaneously displays both said confirmation image and information including said photographing condition in respect to said confirmation image.

5. The apparatus of claim 2, further comprising:
a confirmation-image switching section to switch said confirmation image, displayed on said displaying screen, to a specific confirmation image formed from specific medical image data, which are retrieved from said image data storage, and to which an image-processing based on said new contents, inputted by said inputting section, is applied.

6. The apparatus of claim 5, further comprising:
a confirmation-image fixing section to fix a designated confirmation image, designated among said plurality of confirmation images, on said displaying screen by prohibiting a switching operation to be performed by said confirmation-image switching section.

7. The apparatus of claim 1, further comprising:
a photographing-condition selecting section to select said photographing condition; and
a parameter-determining section to determine said image processing parameter corresponding to said photographing condition selected by said photographing-condition selecting section;
wherein said inputting section inputs said new contents to be changed for said image-processing parameter determined by said parameter-determining section.

8. A method for processing medical image data, which represent a medical image captured by a photographing operation, based on an image processing parameter corresponding to a photographing condition for said photographing operation, said method comprising the steps of:
storing said medical image data in an image data storage;
storing contents of said image processing parameter in a parameter storage;
selecting a specific image-processing parameter, which is intended to be changed, out of image processing parameters stored in said parameter storage;
inputting new contents to be changed for said contents of said specific image-processing parameter;
displaying a confirmation image for confirming a result of changed contents of said specific image-processing parameter on a displaying screen, said confirmation image being generated by applying an image processing to said medical image data retrieved from said image data storage, based on said new contents inputted in said inputting step; and
rewriting said contents currently stored in said parameter storage with said new contents inputted in said inputting step.

9. The method of claim 8,
wherein, in said displaying step, a plurality of confirmation images, which are different relative to each other, and each of which serves as said confirmation image, are displayed on said displaying screen.

10. The method of claim 8,
wherein, in said displaying step, specific medical image data, processed by employing said specific image-processing parameter selected in said selecting step, are retrieved from said image data storage, and an image-processing based on said content, inputted in said inputting step, is applied to said specific medical image data, so as to display said confirmation image on said displaying screen.

11. The method of claim 8,
wherein, in said displaying step, both said confirmation image and information including said photographing condition in respect to said confirmation image are simultaneously displayed.

12. The method of claim 9, further comprising the step of:
switching said confirmation image, displayed on said displaying screen, to a specific confirmation image formed from specific medical image data, which are retrieved from said image data storage, and to which an image-processing based on said new contents, inputted in said inputting step, is applied.

13. The method of claim 12, further comprising the step of:
fixing a designated confirmation image, designated among said plurality of confirmation images, on said displaying screen by prohibiting a switching operation to be performed in said switching step.

14. The method of claim 8, further comprising the steps of:
selecting said photographing condition; and
determining said image processing parameter corresponding to said photographing condition selected in said selecting-condition step;
wherein a content to be changed for said image-processing parameter, determined in said determining step, is inputted in said inputting step.

15. A computer program for processing medical image data, which represent a medical image captured by a photographing operation, based on an image processing parameter corresponding to a photographing condition for said photographing operation, said computer program comprising the executing steps of:
storing said medical image data in an image data storage;
storing contents of said image processing parameter in a parameter storage;
selecting a specific image-processing parameter, whose setting content is intended to be changed, out of image processing parameters stored in said parameter storage;
inputting new contents to be changed for said contents of said specific image-processing parameter;
displaying a confirmation image for confirming a result of changed contents of said specific image-processing parameter on a displaying screen, said confirmation image being generated by applying an image processing to said medical image data received from said image data storage, based on said new contents inputted in said inputting step; and
rewriting said contents currently stored in said parameter storage with said new contents inputted in said inputting step.
